(19) United States
(12) Patent Application Publication
(10) Pub. No.: US 2017/0359228 A1
(43) Pub. Date: Dec. 14, 2017

(54) STREAMING DATA DECISION-MAKING USING DISTRIBUTIONS

(71) Applicant: Nightingale Analytics, Inc., Menlo Park, CA (US)

(72) Inventors: Daniel C. O'Neill, Sunnyvale, CA (US); Sachin Adlakha, Santa Clara, CA (US); Peter T. Pham, Hollister, CA (US)

(21) Appl. No.: 15/619,263

(22) Filed: Jun. 9, 2017

Related U.S. Application Data
(60) Provisional application No. 62/348,717, filed on Jun. 10, 2016.
(60) Provisional application No. 62/348,709, filed on Jun. 10, 2016.

(51) Int. Cl. H04L 12/24; G06N 7/00; G06N 5/04; G06N 99/00

(52) U.S. Cl. CPC H04L 41/147; H04L 41/22; G06N 99/005; G06N 7/005; G06N 5/043

(57) ABSTRACT

An example method comprises receiving a first data stream regarding performance of a monitored system at a first time, determining a plurality of distributions from the first data stream, identifying at least one state for each different distribution of the plurality of distributions to identify a plurality of states, classifying each of the plurality of states into classifications, identifying at least one of the plurality of states as being a problematic state, for each state recognizing one or more transitions from or to other states of the plurality of states, receiving a second data stream of the monitored system at a second time, identifying a precursor state of the plurality of states indicating at least a potential future transition to the problematic state, and generating a warning before the monitored system enters the problematic state.

### CROSS-REFERENCE TO RELATED APPLICATIONS

This application claims priority to U.S. Patent Application Ser. No. 62/348,717, filed Jun. 10, 2016, entitled “Streaming Data Decision-Making,” and U.S. Patent Application Ser. No. 62/348,709, filed Jun. 10, 2016, entitled “Representing Smoothed Non-Parametric Distributions,” which are both incorporated by reference. This application also incorporates by reference the application entitled “Streaming Data Decision-Making Using Distributions with Noise Reduction,” filed herewith.

### BACKGROUND

### 1. Field of the Invention(s)

Embodiments discussed herein are directed to identifying changes in states of a monitored system and taking action (e.g., providing warnings) before a problematic state is reached.

### 2. Related Art

Modern web-facing architectures offer fluidity and agility but at the cost of complexity. For example, microservices, hybrid cloud, continuous deployment, and/or Software Defined Systems (SDX) offer a vast array of functionality, however, they greatly increase management complexity, especially in software defined infrastructures. While complexity in itself is not to be feared, complex systems are difficult to maintain and behavior (at many levels) becomes difficult to predict to avoid loss of data and/or resources.

For example, the rapid change in system configurations, location of virtual machines, and interaction with dynamically deployed microservices can result in complex software component interactions and unexpected problems. These problems can be seen in web-based Business-to-Business (B2B) systems and in Business-to-Consumer (B2C) systems, where standard Linux, Apache, MySQL and PHP/Python/Perl (LAMP) and MongoDB, Express.js, AngularJS and Node.js (MEAN) stacks may have database performance problems related to changes in microservices or network performance issues. Internet-of-Things (IoT) systems are especially sensitive to these issues.

In response, several categories of products have recently been developed. Real-time monitoring and Application Performance Management (APM) tools collect and provide metric information about system and application components. The information is generally stored and/or displayed, giving software development and information technology operations (DevOps) (or operations) data to interpret situations. Based on interpretation of this information, DevOps can decide to take action to improve system performance or resolve immediate problems. A similar procedure is used for log data. In response to DevOps commands, automation tools (e.g., Chef, Puppet, and Ansible) automate tasks to change or redeploy components.

Unfortunately, DevOps personnel are challenged by this procedure. Modern systems can have hundreds of components and thousands of interacting streaming metrics. Presenting DevOps with disordered information that is difficult to interpret, gives rise to “alarm fatigue and dashboard haze.” High resource usage measurements (e.g., CPU and page faults) are the result of other problems that build over time. As a consequence, DevOps is often reacting to problems after they occur and bearing the financial cost of degraded systems.

### SUMMARY OF THE INVENTION(S)

An example method comprises receiving a first data stream regarding performance of a monitored system at a first time, determining a plurality of distributions from the first data stream, identifying at least one state for each different distribution of the plurality of distributions to identify a plurality of states, classifying each of the plurality of states into classifications, identifying at least one of the plurality of states as being a problematic state, for each state of the plurality of states, recognizing one or more transitions from or to other states of the plurality of states, receiving a second data stream indicating performance of the monitored system at a second time, identifying a precursor state of the plurality of states based on the second data stream indicating at least a potential future transition to the problematic state, and generating a warning before the monitored system enters the problematic state, thereby enabling the monitored system or an operator to make changes in the monitored system to reach another state of the plurality of states before the transition to the problematic state.

This may include data from a sensor or transactional business data. In some embodiments, the data stream may be received from application performance management (APM) tools providing metric information regarding performance of at least one application.

In various embodiments, determining the plurality of distribution from the data stream comprises computing probabilities across dimensions of the first data stream and aggregating the probabilities into the plurality of distributions. The method may comprise generating a list of states based on the identified plurality of states. In some embodiments, the first data stream is regarding a single metric of the monitored system.

Identifying the precursor state of the plurality of states based on the second data stream may include identifying the precursor state based on an expected future transition to the problematic state utilizing, at least in part, behaviors identified from the first data stream. The method may further comprise taking action in the monitored system to change a current state of the monitored system from the precursor state to a different state. The method may further comprise displaying a dashboard displaying information regarding at least one of the states of the plurality of states based, at least in part, the second data stream.

An example non-transitory computer readable medium may comprise instructions, that, when executed, cause one or more processors to perform a method. The method may comprise receiving a first data stream regarding performance of a monitored system at a first time, determining a plurality of distributions from the first data stream, identifying at least one state for each different distribution of the plurality of distributions to identify a plurality of states, classifying each of the plurality of states into classifications, identifying at least one of the plurality of states as being a problematic state, for each state of the plurality of states, recognizing one or more transitions from or to other states of the plurality of states, receiving a second data stream indicating performance of the monitored system at a second time, identifying a precursor state of the plurality of states based on the second data stream indicating at least a potential future transition to the problematic state, and generating a warning before the monitored system enters the problematic state, thereby enabling the monitored system or an operator to make changes in the monitored system to reach another state of the plurality of states before the transition to the problematic state.

An example system may comprise one or more processors and memory comprising instructions to configure at least one of the one or more processors to receive a first data stream regarding performance of a monitored system at a first time, determine a plurality of distributions from the first data stream, identify at least one state for each different distribution of the plurality of distributions to identify a plurality of states, classify each of the plurality of states into classifications, identifying at least one of the plurality of states as being a problematic state, for each state of the plurality of states, recognize one or more transitions from or to other states of the plurality of states, receive a second data stream indicating performance of the monitored system at a second time, identify a precursor state of the plurality of states based on the second data stream indicating at least a potential future transition to the problematic state, and generate a warning before the monitored system enters the problematic state, thereby enabling the monitored system or an operator to make changes in the monitored system to reach another state of the plurality of states before the transition to the problematic state.

### BRIEF DESCRIPTION OF THE DRAWINGS

FIG. 1 depicts an example environment in which embodiments may be practiced.

FIG. 2 is a diagram of an analysis system in some embodiments.

FIG. 3 is a flowchart for generating distributions based on streaming and/or other data in some embodiments.

FIG. 4 depicts a display of an example of ADC data that indicates different behaviors (e.g., states).

FIG. 5 depicts example database metrics which are shifting from one generating distribution to another (e.g., A-M) in response to different network traffic conditions and Write Ahead Log latencies in some embodiments.

FIG. 6 is an example visualization for a monitored system in some embodiments.

FIG. 7 is a block diagram of an analysis of data streams in some embodiments.

FIG. 8 depicts output graphs of synthetic data in an example embodiment.

FIG. 9 depicts graphs of example behavior of PAI with MongoDB.

FIG. 10 shows example results of PAI with MongoDB.

FIG. 11 depicts a system structure and the Q-List for an example system and one of the components.

FIG. 12 is a flowchart for analyzing streaming data and providing warnings in some embodiments.

FIG. 13 is an example prediction dashboard in some embodiments.

FIG. 14 is an example interaction prediction dashboard in some embodiments.

FIG. 15 is an example monitoring dashboard in some embodiments.

FIG. 16 is an example monitoring dashboard to view multiple metrics associated with a database in some embodiments.

FIG. 17 is an example monitoring dashboard including multiple panes in some embodiments.

FIG. 18 is an example behavior dashboard to view shapes of streaming data in some embodiments.

FIG. 19 shows the displays details of a particular behavior. Behaviors are computed using available metrics.

FIG. 20 is a dashboard for interpreting and comparing behaviors in some embodiments.

FIG. 21 is a dashboard for remediation in some embodiments.

### DETAILED DESCRIPTION OF DRAWINGS

Enterprises today receive data streams from a myriad of data sources. Data streams may include, for example, sensor data, mobile device data, market data, clickstreams and transactional business data. Information contained in data streams is typically valuable if the information can be acted upon in a timely fashion. It is not enough to store massive volumes of data, perform batch based historical analysis, and respond later. As the velocity of business increases, enterprises need to process large volumes of streaming structured and/or unstructured data from disparate sources, detect insights from these data streams, and take immediate action.

For example, payment facilitators, such as PayPal, Braintree, or WePay, are responsible for recovering chargebacks from merchants when fraudulent transactions take place. If the merchant is unable to pay, these payment facilitators are liable for funds that cannot be recovered. Payment facilitators collect a variety of streaming data from merchants including transaction volume, average order value, reauthorization velocity, and the like. This data may be used to continuously assess merchant behavior and look for signs of credit risk or “bust out.” Because merchant behavior evolves over time, a historical analysis of merchant's transaction data does not provide an accurate, up-to-date picture of the risk posed by the merchant.

With the growth of connected devices, enterprises today see a deluge of data from machines and sensors. The amount of data received by businesses is only growing but the information within the data creates new opportunities. Sensor data collected from devices, equipment, meters, and personal appliances has the potential to transform business in many markets. In healthcare, for example, smart sensors can continuously monitor and interpret patient health. The care team can use this streaming sensor data to learn what constitutes a normal physiological state for each patient on an individual basis and preempt emergencies when the patient's condition becomes abnormal.

In another example, streaming data from sensors embedded in cars can be used by insurance companies to monitor driving patterns of their customers and assess risk. A driver that commutes outside of rush hours will likely have a lower risk profile. Insurance companies can also detect driving styles related to distraction and alert the driver to prevent serious accidents. In these and many other examples, the interpretation of sensor data allows enterprises to understand the state of their employees, customers, and/or assets. This can fundamentally change the way they do business and can drive new business models that provide improved services and achieve better results at a lower cost.

To leverage data, business needs technologies that allow them to convert streaming data to decisions. Some embodiments herein describe a new technology that allows businesses to take structured and unstructured streaming data, extract statistically important information, and make decisions.

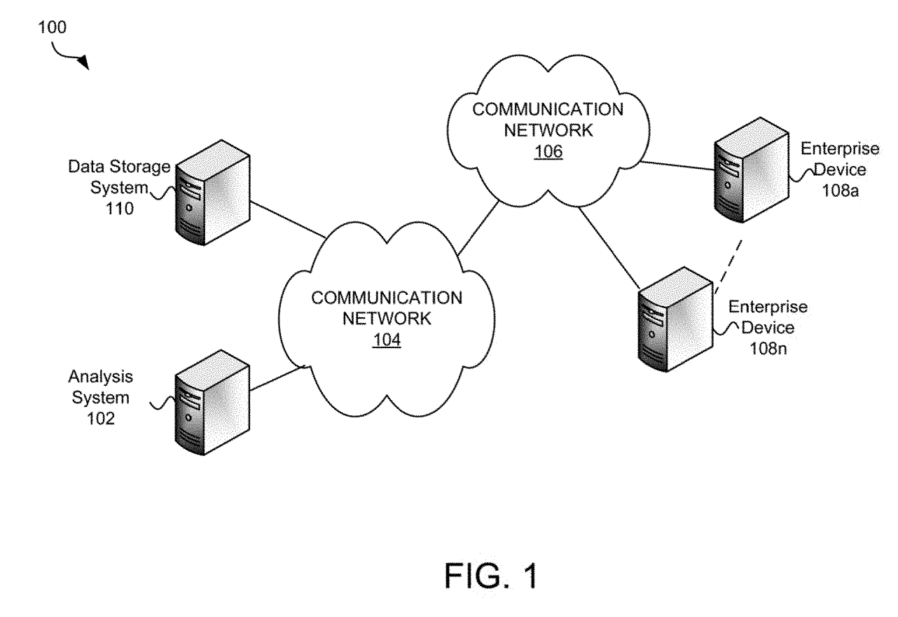

FIG. 1 depicts an example environment 100 in which embodiments may be practiced. In various embodiments, data analysis and/or visualizations (e.g., graph visualizations of dashboards) may be performed locally (e.g., with software and/or hardware on a local digital device), across a network (e.g., via cloud computing), or a combination of both. Data regarding a monitored system may be received from any number of sources. For example, as discussed herein, streaming data may include but is not limited to, sensor data, mobile devices, market data, clickstreams, metric information, logs, transactional business data, and/or performance data. Data may also be obtained from any number of data structures for analysis.

The analysis system 102 may include a cloud platform for managing Software as a Service (SaaS). In some embodiments, the cloud platform may provide an integrated prediction oriented management view of applications, databases, systems, and/or subsystems. For example, the cloud platform may provide resources to enable DevOps to identify a state of an application, components, systems, hardware and/or software, identify a future problematic state, as well as provide warnings before problems occur. In some embodiments, the cloud platform associated with the analysis system 102 may also provide recommendations or automate responses to change the current state of the hardware, components, systems, and/or software to reach a safer, non-problematic state.

The monitored system may include any number devices, networks, software assets, and/or hardware assets (e.g., enterprise devices 108a-n and/or data storage system 110). The monitored system may, for example, include hardware or software for providing microservices, continuous deployment, and/or Software Defined Systems (SDX). The monitored system may include, for example, Business-to-Business (B2B) systems and/or Business-to-Consumer (B2C) systems. The monitored system may include, for example, Internet-of-Things (IoT) devices and/or components. The monitored system may include one or more hybrid clouds, clusters, or components.

Environment 100 comprises analysis system 102, enterprise devices 108a-n, and data storage system 110 that communicate over communication networks 104 and 106. In this example, environment 100 depicts an embodiment wherein functions are performed across a network. User(s) may take advantage of cloud computing utilizing any number of data storage systems 110, servers, digital devices, and the like over any number of communications networks (e.g., communication network 104). The analysis system 102 may perform analysis and generation of any number of visualizations, reports, and/or analysis.

Analysis system 102, data storage system 110, and the enterprise devices 108a-n may be or include any digital devices. A digital device is any device that includes memory and a processor. The enterprise devices 108a-n may be or include any kind of digital device used to access, receive, generate, direct, analyze and/or view data including, but not limited to, a desktop computer, server, application service, laptop, notebook, or other computing device. One or more enterprise devices 108a-n may generate or receive streaming data as discussed herein.

In some embodiments, any number of the enterprise devices 108a-n may include hardware devices such as printers and scanners. It will be appreciated that some of the enterprise devices 108a-n may include software that generates information (e.g., logs, update information, information requests, metric data, sensor data, and/or the like).

Although enterprise devices 108a-n are identified as “enterprise,” the devices 108a-n may be a part of any business, enterprise, organization, or complex system. Further, the devices 108a-n may be associated with multiple businesses, enterprises, organizations, or complex systems.

Modern IT systems (e.g., that include enterprise devices 108a-n) may collect large amounts of streaming data about the performance of the system itself. This may be in addition to the work done by the system for users. As discussed herein, this data can be very difficult interpret, leaving IT DevOps managers in a difficult situation. Imagine having to look at every sensor value generated by your car and, in real time, command the car to adjust fuel, air, and spark mixtures. For IT, this is especially difficult since there may be no readily derivable (e.g., physics based) relationships between the software components. Nevertheless, DevOps (the car driver in this metaphor) is responsible for making real time operational decisions for IT systems (the car).

IT data in this example may be in the form of metrics (time series) that measure actions and operations of software running in a system (e.g. databases, operating systems, web servers, load balancers). Commonly, systems collect thousands to hundreds of thousands of metrics. The statistical structure of the data changes over time and is not stationary.

The analysis system 102 may receive information from data storage system(s) 110, enterprise devices 108a-n (e.g., including the IT data such as software logs, hardware logs, monitoring information from devices, and software configured to monitor hardware and software assets, and the like). The analysis system 102 may condense the data into an interpretable form, detect important relationships between software services and components, predict and/or warn of problems before they occur, and optionally identify actions to avoid the problem(s). In various embodiments, the analysis system 102 may provide software as a service for any or all functions discussed herein.

In some embodiments, the analysis system 102 receives information regarding the monitored system, identifies states of any number of systems, subsystems, or combination of systems, classifies those states, monitors new information to determine changes in state, and provides warnings if the new state is likely or associated with an undesirable condition. For example, the analysis system 102 may provide a warning if the system reaches a state that will or will likely reach a problematic state (or achieve an undesirable condition that may damage the system, overwhelm resources, trigger error conditions, or the like). The analysis system 102 may generate warnings before the state(s) of the monitored system reaches the undesirable condition.

In various embodiments, the enterprise device 108a may generate data to be provided to and/or receive data from a database or other data structure. The enterprise device 108a may communicate with the analysis system 102 via the communication network 104 and/or 106 to perform analysis, perform examination, detect changes in state, receive warnings of problems (preferably before the problems occur), and/or receive a visualization representing at least some of the data of the target system.

The communication networks 104 and 106 may be or include network that allows digital devices to communicate. For example, the communication network 104 may be the Internet and/or include LAN and WANs. Communication network 106 may be or include any number of target system networks (e.g., including an Enterprise private network). The communication networks 104 and 106 may support wireless and/or wired communication.

The data storage server 110 is a digital device that is configured to store data. In various embodiments, the data storage server 110 stores databases and/or other data structures. The data storage server 206 may be a single server or a combination of servers. In one example the data storage server 110 may be a secure server wherein a user may store data over a secured connection (e.g., via https). The data may be encrypted and backed-up. In some embodiments, the data storage server 110 is operated by a third-party such as Amazon's S3 service.

The database or other data structure may comprise large high-dimensional datasets. These datasets are traditionally very difficult to analyze and, as a result, relationships within the data may not be identifiable using previous methods. Further, previous methods may be computationally inefficient.

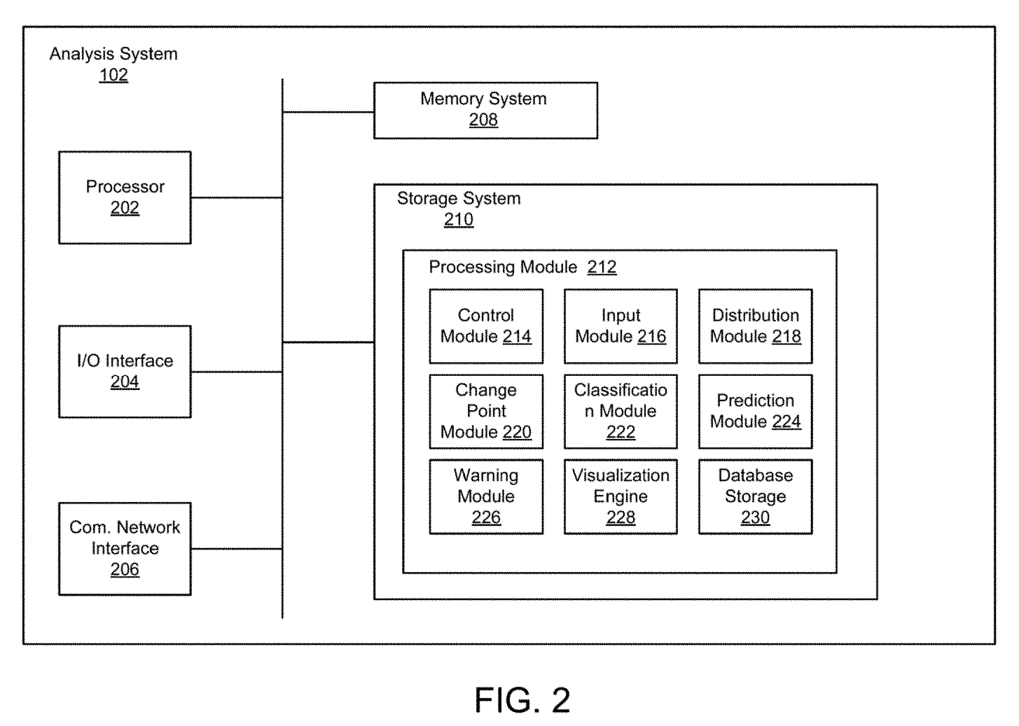

FIG. 2 is a diagram of an analysis system 102 in some embodiments. The analysis system 102 comprises a processor 202, input/output (I/O) interface 204, a communication network interface 206, a memory system 208, a storage system 210, and a processing module 212. The processor 202 may comprise any processor or combination of processors with one or more cores. While the analysis system 102 is depicted in FIG. 2 as being a single digital device, it will be appreciated that the analysis system 102 may be or include any number of digital devices (e.g., the analysis system 102 may include or be a part of a cloud or hybrid system).

The input/output (I/O) interface 204 may comprise interfaces for various I/O devices such as, for example, a keyboard, mouse, and display device. The example communication network interface 206 is configured to allow the analysis system 102 to communication with the communication network(s) 104 and/or 106 (see FIG. 1). The communication network interface 206 may support communication over an Ethernet connection, a serial connection, a parallel connection, and/or an ATA connection. The communication network interface 206 may also support wireless communication (e.g., 802.11 a/b/g/n, WiMax, LTE, WiFi). It will be apparent to those skilled in the art that the communication network interface 206 can support many wired and wireless standards.

The memory system 208 may be any kind of memory including RAM, ROM, or flash, cache, virtual memory, etc. In various embodiments, working data is stored within the memory system 208. The data within the memory system 208 may be cleared or ultimately transferred to the storage system 210.

The storage system 210 includes any storage configured to retrieve and store data. Some examples of the storage system 210 include flash drives, hard drives, optical drives, and/or magnetic tape. Each of the memory system 208 and the storage system 210 comprises a non-transitory computer-readable medium, which stores instructions (e.g., software programs) executable by processor 202.

The storage system 210 comprises a plurality of modules utilized by embodiments of discussed herein. A module may be hardware, software (e.g., including instructions executable by a processor), or a combination of both. In one embodiment, the storage system 210 may include a processing module 212. The processing module may include, but is not limited to, a control module 214 for controlling one or more other modules or one or more functions of modulates, an input module 216 to receive data streams, a distribution module 218 to create distributions from the data streams, a change point module 220 to identify any number of states from the distributions and/or identify changes in state, a classification module 222 to classify states, a prediction module 224 to identify relationships between states, a warning module 226 to provide warnings before problems occur or a problematic state is reached, a visualization engine 228 to generate graph and/or dashboard visualizations, and a database storage 230 to store any or all information regarding the streaming data, states, classifications, models, predictions, warnings, visualizations, and/or the like.

While analysis system 102 is depicted in FIG. 2 as including all modules as shown in FIG. 2. It will be appreciated that any or all functions described herein may be distributed over any number of devices and/or resources (including cloud devices).

In some embodiments, the analysis system 102 may utilize an approach using Predictive Augmented Intelligence (PAI) to solve or assist in solving one or more problems discussed herein. In one example of this approach, the input module 216 of the analysis system 102 may ingest Application Performance Management (APM) and/or log data from a monitored system. The distribution module 218 and the change point module 220 may find inherent statistical classes (states) in the data. The classification module 222 may label and/or identify statistical classes. The prediction module 224 may predict behaviors of the target system. The warning module 226 may generate warnings and/or alerts of potential problems before they occur (e.g., based on the prediction from the prediction module 224).

In some embodiments, PAI may be used by the analysis system 102 to augment the DevOps professional by assisting with the presentation of a concise roadmap of all or part of the monitored system (e.g., a subsystem of the monitored system), a current location on a state map, and identification of possible problems and possible future states. Given this state map and prediction, the analysis system 102 may recommend actions to DevOps. or the analysis system 102 can take these actions automatically. This may allow DevOps to preemptively solve problems, increasing efficiency, and/or improve consistency.

The input module 216 may receive streaming data and/or any other data from any number of sources. For example, the input module 216 may receive metric information about system and application components in real-time from monitoring products and/or Application Performance Management (APM) tools. In another example, the input module 216 may receive sensor data, mobile devices, market data, clickstreams, metric information, logs, transactional business data, and/or performance data.

The analysis system 102 may identify states of all or part of the monitored system (e.g. components, subsystems, systems, or the like). A state may include distributions of received data. The distribution module 218 generates non-parametric distributions based on any or all information received by the input module 216 (e.g., distributions may be generated by any number of data streams and/or portions of data streams). The distribution module 218 may compute succinct representations of multi-dimensional non-parametric distributions from sample numeric and categorical data from the input module 216. The distribution module 218 may also update these distributions based on new data (e.g., later received streaming data). The distribution module 218 may, in some embodiments, provide rapid estimation of any number of distributions in terms of sample points using a constant memory footprint.

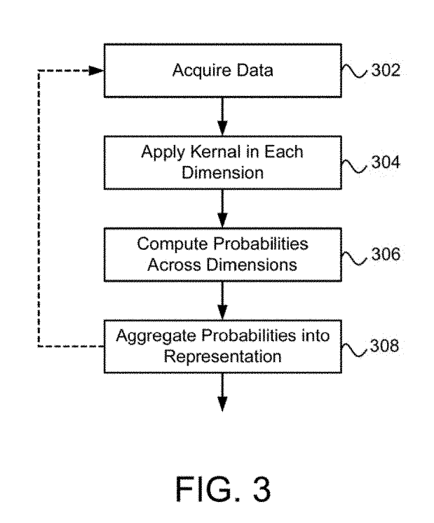

FIG. 3 is a flowchart for generating distributions based on streaming and/or other data (e.g., data from APM tools and sensors including metrics and the like) in some embodiments. In various embodiments, the distribution module 218 may estimate, represent, and/or manipulate non-parametric probabilistic distributions. In step 302, the input module 216 receives sample data (e.g., streaming data). The sample data may take the form of numeric and or categorical data and may be partitioned based on the originating entities or other definitional properties. The data may be structured, partially structured, or unstructured.

In step 304, the distribution module 218 applies pre-selected distributional kernels to each sample in each dimension. Each dimension may have a distinct kernel selected based on the natural characteristics of that dimension (e.g., based on known characteristics and/or parameters of that dimension of the data). In the categorical case, distributions may be imputed from external information.

In step 306, the distribution module 218 combines probabilities across dimensions to compute the joint distribution defined by the selected kernels and the sample data. The independences between dimensions may be pre-specified (e.g., based on known characteristics and/or parameters of that dimension of the data) and influence the computation of the joint distribution.

In step 308, the distribution module 218 aggregates the joint probabilities across samples from the same partition into a fixed representation of the distribution for that partition. States may be distributions of data over a large number of dimensions that correspond to component and system behaviors.

It will be appreciated that Software Defined Systems (SDX) can change quickly and as a consequence the statistical structure of metric and log data will also change. Different behaviors correspond to different statistical distributions (e.g., different states).

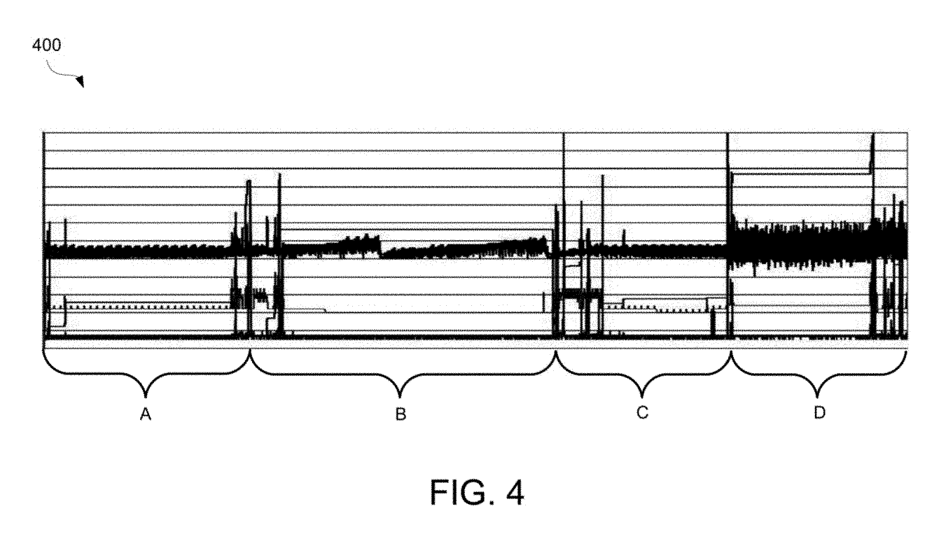

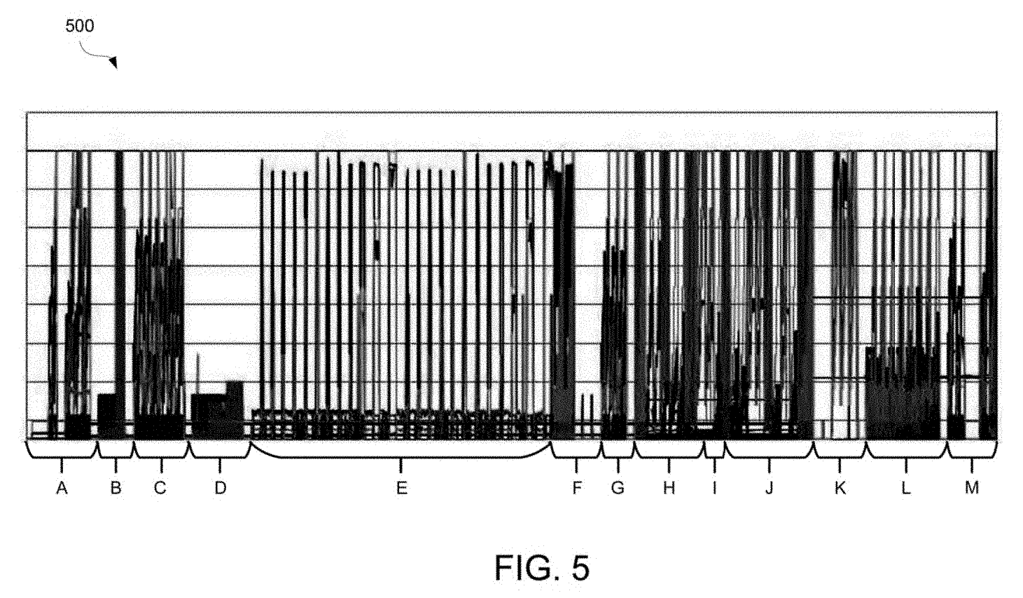

FIG. 4 depicts a display 400 of an example of ADC data that indicates different behaviors (e.g., states). The ADC is operating in four distinct behaviors (e.g., A-D) in response to changing VM locations of the components it is connected with, and the ADC is generating samples from the four different generating distributions. Likewise, FIG. 5 depicts example database metrics 500 which are shifting from one generating distribution to another (e.g., A-M) in response to different network traffic conditions and Write-Ahead Log latencies in some embodiments. When DevOps describes a system as having a particular behavior in a particular interval of time, they are associating system or component behavior with the metrics during that interval, explicitly labeling that interval of metrics, and implicitly labeling the underlying generating distribution.

Statistically, software defined systems (SDX) generate non-stationary time series data, where different generating distributions are at work in different intervals of time. This can be described as a sequence of different generating distributions pₖ, kεK, where K is the set of generating distributions and may evolve over time. A given generating distribution pₖ yields metric samples xₖ(t), tεT, where T is the set of time intervals in which pₖ is in operation. In FIG. 4, there are four generating distributions, and each generating distribution is generating a different number of samples and runs for a different period of time. The dimension of x can be moderate (e.g., 100 for MongoDB) or very large for a complete system (e.g., 1 million for Facebook). Unfortunately, the generating distributions p, and the set K, may be unknown and can change over time with changes to the system.

Some embodiments described herein determine an on-line condensation of SDX data that is useful for describing system and component behaviors and that can also be used to predict future behaviors. In an example system, constraints and approaches are described in the following table. It will be appreciated that constraints and approaches may be different for different systems. Note, a system can sometimes transition from one behavior to one of several behaviors. This set may be limited to probable next behaviors (e.g., three). Here, there may be fewer than three behaviors.

Example Design Issues

| Example | Example | Example |
|---|---|---|
| Constraints | Approach | Comments |
| On-line | Real-time processing | |
| Evolving K | Adaptive update | Running list |
| Unknown {pₖ} | Estimate T(pₖ) | Distribution |
| | | space |
| High dimension | Hierarchy | Aggregation |
| Prediction | Prediction of next | Up to top three |
| | behavior(s) | possible |
| | | behaviors |
| Remediation | Leverage Tools | |

In various embodiments, the change point module 220 may extract (e.g., identify) statistically informed states (SIS) from streaming data. For streaming data, a statistically informed state (or SIS) is a statistical summarization of the data stream that contains information that may be used for decision-making. A state may be the summarization of the system and may allow for behavior prediction. In mechanical systems and control processes, the state is typically obtained based on physical characteristics. For example, the position and velocities of a mechanical system are typical state variables. In contrast, a statistically informed state is based on the underlying statistics of the data stream and allows a decision maker to make decisions even in absence of the raw stream.

One example of a statistically informed state is as follows:
Given a window w=(x₁, x₂, . . . , xₙ) of data, define P_{w} to be the type associated with this window and is given by equation (1). Label L_{w} is assigned to this type which associates decision information with this type. Then, the statistically informed state associated with this window is given by the tuple:

SIS_{w}=(P_{w},L_{w}).

As discussed herein, a statistically informed state may be extracted from streaming data. In one example, consider a window of length n of the data stream. The choice of length n is selected by an acceptable delay in detecting changes in the data stream. A large value of window size means that the algorithm (e.g., analysis system 102) may need to collect more samples before making any decision. The change point module 220 may convert the window of data into type space using binning. For example, B bins may be utilized for each data dimension; that is, if the data sample xᵢ is in d-dimensions, then B^{d} total bins may be used to construct the histogram. The histogram is an approximation of the actual probability distribution or the type associated with window of the data. By increasing the number of bins, there may be progressively better approximations to the window's type. For each bin bεB^{d}, the change point module 220 may count the number of data elements that lie within that bin. This empirical probability density function gives the type associated with the window.

The classification module 222 may assign each window (e.g., each state) a label. The labels may be provided by an entity associated with the monitored system (e.g., IT, users, administrators, or the like). In various embodiments, the label may indicate if the state is a problematic state which is associated with undesirable performance, resource restrictions, and/or data loss.

The change point module 220 described herein, may assign an SIS to every length n window of the data stream. Given two windows w and w′ that have similar (but not identical) empirical distributions, a question is whether they have the same statistically informed state. Intuition suggests that if two windows have similar distributions, then statistically speaking they have the same state. To measure similarity between empirical distributions or types associated with two different windows, the change point module 220 may utilize a Jensen-Shannon divergence (JSD) as the distance measure.

Given two probability distributions or types P and Q, the Jensen-Shannon divergence is defined as:

$$JSD ( P ‖ Q ) = \frac{1}{2} D ( P ‖ M ) + \frac{1}{2} D ( Q ‖ M )$$

Where

$$M = \frac{1}{2}$$

(P+Q) and D(P∥Q) is the Kullback-Leibler divergence

Jensen-Shannon divergence is symmetric and has finite value; these properties may enable measuring between two distributions. Given two windows w and w′, the types associated with these two windows (denoted by P_{w} and P_{w′}) are similar if JSD(P_{w}∥P_{w}′)≦δ, where δ is a parameter of choice. Two windows w and w′ are similar if their JSD distance is less than a similarity parameter.

The similarity parameter δ may control how many data sequences of length n can be represented by a single type. For a small value of δ, minor variations in the incoming data stream would lead to signicantly different types; this allows decision makers to make finer resolution decisions. In contrast, a larger δ implies that the entire data stream can be represented using only a few statistically informed states; this leads to significant reduction in complexity. The choice of this tunable parameter is informed by the decision maker and the specific problem.

The change point module 220 may utilize statistically informed states as a fundamental object. In various embodiments, at each time t, the change point module 220 and/or the classification module 222 may maintain a list (denoted by L) of all statistically informed states associated with the data stream seen so far. At t=0, this list is empty. At time t+1, a window of the data stream is mapped into the type space using the method described above; this is denoted as new type by Pₜ₊₁. The change point module 220 may compare the Jenson Shannon divergence of this new type to all SIS maintained in the list L. If for any type PεL*, JSD(P∥Pₜ₊₁)≦δ, then the new type may be discarded. Otherwise, the new type may be added to the list L.

For each new type added to the list L, the classification module 222 may assign a label to the type. The label may represent a meaning associated with this type (and hence the window of data). For example, consider a temperature sensor that sends a stream of temperature readings. If a window of this stream has normal fluctuations, then the type associated with that window may be assigned a “normal operation” label. If however a particular window of temperature readings represents unusual temperature fluctuations, then the type associated with that window may be assigned an “abnormal operation” label.

The statistically informed states in the list L may form a tessellation of the type space. This tessellation may depend on a similarity parameter δ. For example, a smaller similarity parameter may lead to a larger number of statistically informed states in the list L, which in turn implies a finer tessellation of the type space. This tessellation of the type space may allow for understanding of changes in streaming data.

In an IoT example, consider the tessellation of the type with three statistically informed states given by:
L={(P₀=Normal Operating Region), (P₁=Boiler Pressure Abnormal), (P₂=Motor Overheating)}

In this example, at time t a new window of data wₜ is given. The change point module 220 may first map this window of data into a type P_{w}. The change point module 220 then compares Jenson Shannon divergence of this new type to all types in the list L. If the new type P_{w} is similar to P₀, this means that system is operating normally at time t. If however, the type P_{w} is similar to type P₂, then the data indicates an overheating motor. If the type P_{w} is dissimilar to all types in the list L, this means that the data window at time t, represents a statistically new state. In this case, the classification module 222 adds the new type P_{w} along with an associated label to the list L. In this way, the method of types algorithm continuously expands the set of conditions.

It will be appreciated that some embodiments described herein may offer benefits of dimensionality reduction. Some embodiments described herein converts a window of streaming data into a type using histogram construction. For d dimensional streams, a window of length n is converted into a type that can be represented using B^{d} bins. Since in general n>>b, this conversion into type space reduces the data needed to accurately capture the system's characteristics. Furthermore, in some embodiments, a large number of most typical sequences can be represented by a single type. This means that one needs to keep track of only a few SIS states to understand the changes in data streams.

Some embodiments described herein may also at least partially reduce problems of non-stationarity and drift. A key challenge in making decisions from streaming data is the ability to handle changes in input data distributions (non stationarity) and changes in the relationship between the input data and the target variables (drift). Some embodiments described herein may handle both such changes. For example, changes in the incoming data streams either due to non-stationarity or drift may cause changes in types associated with these streams. After these new distributions are labelled, the new statistically informed states (SIS) may allow operators to make decisions based on the new input distributions.

In various embodiments, the change point module 220 may convert a window of data into a type represented by the window's empirical distribution. This approach may reduce sensitivity to noise (e.g., this approach may be insensitive to noise). For example, slight variations in sensor values may not lead to major differences (or different states). As a result, warnings and alarms may not be triggered until there is a meaningful change in the data (e.g., there is a reduction of “false” warnings indicating changes in state when there was not a significant change in the data).

It will be appreciated that, in some embodiments, states are labeled (e.g., decision regions are labeled in the type space). This approach is more expressive than thresholding in the sample space and may allow operators to generate complex decision regions for their equipment and processes.

In various embodiments, the change point module 220 and/or the classification module 222 may determine transitions between states based on the data stream(s). For example, as the analysis system 102 “learns” by identifying new states based on distributions of data in data streams, the change point module 220 and/or the classification module 222 may identify transitions from any or all states to other states by the monitored system. Similarly, the change point module 220 and/or the classification module 222 may identify transitions to any or all states from other states by the monitored system. Based on the received data stream (and/or information provided by one or more operators or administrators of the monitored system), the change point module 220 and/or the classification module 222 may develop a summary of expected transitions between states.

After states have been identified and/or classified, the prediction module 224 may assess a current state (e.g., based on a new or current data streams) to determine a likelihood of a problematic state being reached. In some embodiments, the classification module 222 and/or information from an administrator (e.g., from an administrator digital device), may identify problematic states (e.g., from the list L) and include metadata indicating the problem and/or seriousness. In various embodiments, the prediction module 224 may determine a probability or confidence score of likelihood of a problematic state of being reached from a current state.

A warning module 226 may generate a warning or alert if the prediction module 224 and/or the warning module 226 determines that one or more problematic states are likely to be reached. In some embodiments, an administrator or a default threshold is identified. The warning module 226 may compare a likelihood of a problematic state of being reached to the threshold. Based on the comparison (e.g., the likelihood of a problematic state is greater, less than, or equal to the threshold), the warning module 226 may generate a warning or alert.

The warning module 226 may provide the warning or alert in any number of ways. In some embodiments, the warning module 226 provides the warning or alert as a message such as a pop-up message of an administrator, text message, email, call, or the like. In some embodiments, the warning module 226 may generate any number of API calls and information to systems or subsystems to enable the systems or subsystems to take action or to provide alerts and/or warnings. The warning module 226 may provide the warning or alert to any number of digital devices or analog devices. In some embodiments, the warning module 226 requires an acknowledgement in response to the warning or the alert. If there is not an acknowledgment within a predetermined period of time, the warning module 226 may escalate and/or provide the warning or alert to another device and/or group of devices.

It will be appreciated that the warning module 226 may take action to avoid the problematic state from being reached. In some embodiments, the warning module 226 may have a set of one or more actions that may be taken when one or more states are reached or a likelihood of reaching a problematic state is reached. The set of one or more actions may be selected or chosen by an administrator, another device, or the like. Any one or combination of the set of one or more actions may change the current state of all or part of the monitored system to a different state, thereby avoiding the problematic state (e.g., avoiding damage, loss of data and/or limitations of resources).

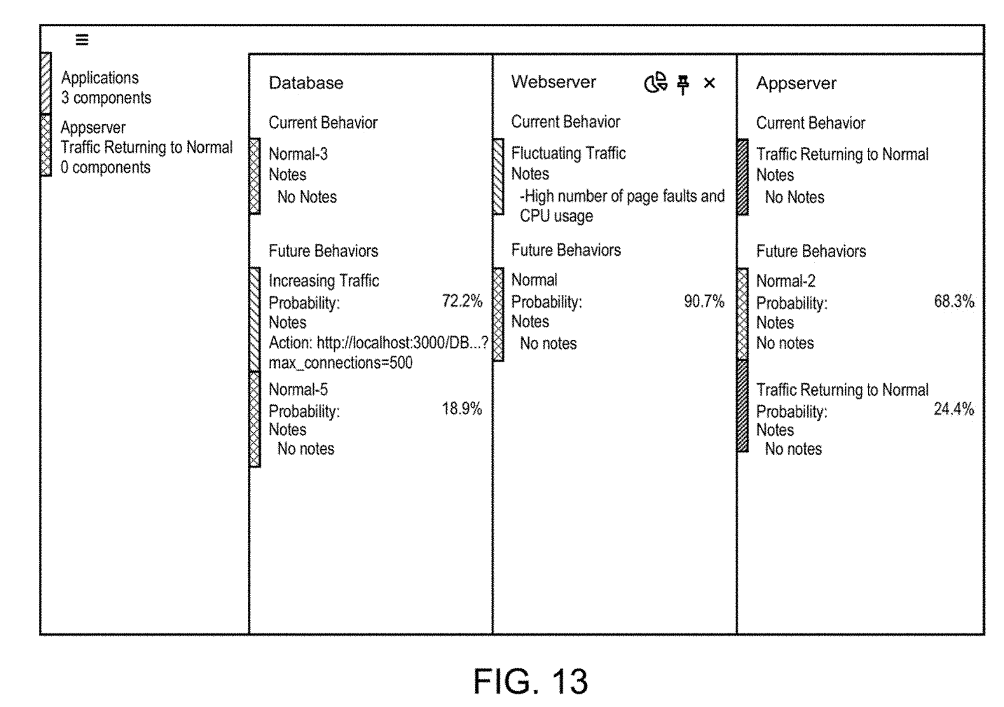

The visualization engine 228 may generate visualizations and/or dashboards. It will be appreciated that the visualization engine 228 is optional. The warnings and/or alerts generated by the warning module 226 do not require a visualization or a dashboard. Example dashboards are depicted in FIGS. 13-21.

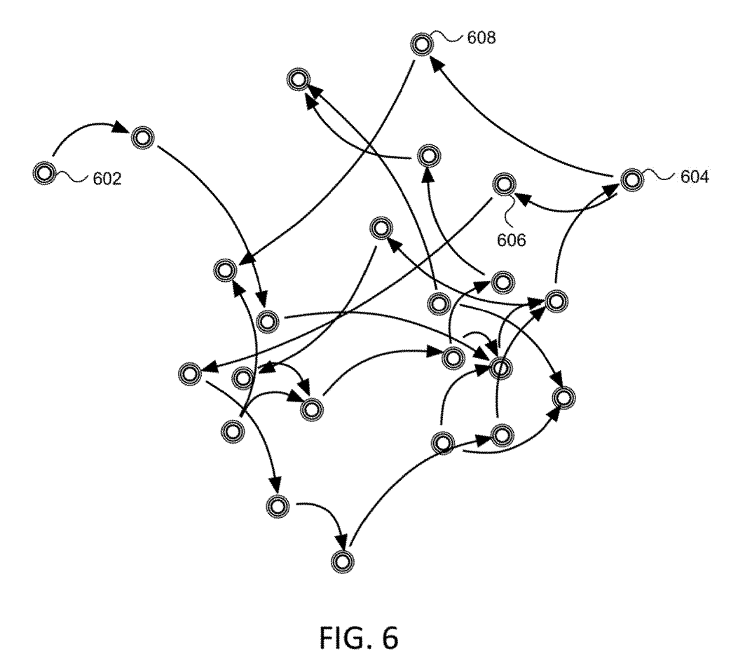

FIG. 6 is an example visualization for a monitored system in some embodiments. Each ball or node may represent a state. Each pathway (e.g., edge) between nodes (e.g., states or balls) indicates a possible transition to a state (e.g., a behavior) that may be reached from another state. The arrows indicate the direction of the transition. Each edge may, in some embodiments, be associated with a relative frequency occurrence. It will be appreciated that a state may have two or more subsequent states that may be transitioned to depending on factors. For example, node 604 has two subsequent states that may be reached, including node 606 and node 608. If node 606 represents a problematic state, the warning module 226 may generate a warning and/or take action to increase the likelihood (or ensure) that the next subsequent state is node 608.

Note, in this example, FIG. 6 does not depict a state-space visualization. The arcs between balls may correspond to directed changes in state. The intensity of the arcs correspond to the probability of that arc. In this example, the database walks from one state to another along these arcs. Behaviors are paths along these arcs.

In some embodiments, behaviors and states (e.g., node 602 and other nodes) are color coded. A behavior or state transitioning to an adverse system condition (e.g., problematic behavior or problematic state) may be marked as a warning state (e.g., yellow). A warning state may trigger the analysis system to issue a warning. The warning issued by the analysis system 102 may indicate that a monitored system is on a path to an adverse condition, but which has not yet occurred (i.e., a warning is not an alert that the adverse condition has already occurred). Each behavior and state can be associated with an action in a triple of the form:

((current behavior Bₖ),(predicted behavior Bₖ₊₁),(Action Aₖ₊₁)) (1)

In some embodiments, actions, Aₖ₊₁ may include a script, recipe (Chef), Page (PagerDuty), or Warning text or email.

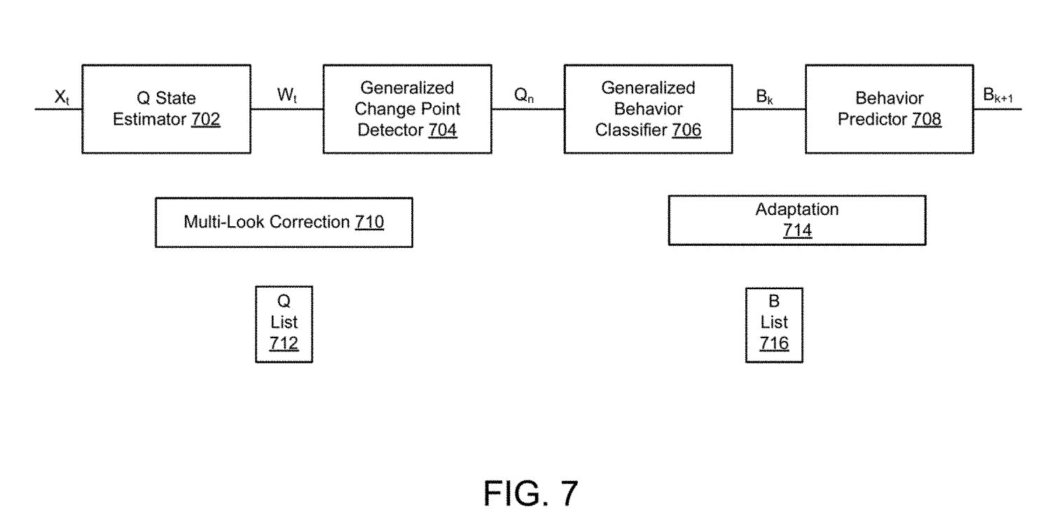

FIG. 7 is a block diagram of an analysis of data streams in some embodiments. In this example, the input module 216 receives input data x from APM tools and/or Log Analytics products. The outputs for this example are, first, current behavior of the system Bₗ and, second, the predicted behavior of the system {Bₗ₊₁}. The set {Bₗ+1} is the set of most probable next behaviors. In this example, this set is one or two behaviors, and may be limited to three.

In some embodiments, the input module 216 receives data x. The distribution module 218 and/or the change point module 220 transforms the data x into a “candidate” state w. In one example, the Q state estimator 702 transforms Xₜ into candidate state w. The generalized change point detector 704 (e.g., change point module 220) may compares the candidate state with the current state Q. If the candidate state is statistically similar to the current state Q, then the current state Q is left unchanged. If the candidate state is sufficiently different, it may be marked. In some embodiments, the change point module 220 may review additional data aggregated to confirm that there has been a change in system state or behavior. A Multi-Look correction module 710 may correct for errors as more data is collected.

In this example, if there has been a state change, then one of two actions may be taken. If the new state Q* is in the Q-List 712, the analysis system 102 may: (1) update a monitored system state, (2) inform DevOps, and (3) refine an estimate of this state. If the new state Q* is not on the Q-List 712, the analysis system 102 may still update the current state, and then, if Q* is sufficiently different, the generalized behavior classifier 706 may request a new label (e.g., the classification module 222 may associate the new state with a new label). In various embodiments, the analysis system 102 may utilize this system to warn of new Black Swan events.

Behaviors Bₖ can be a single state or a sequence of states, depending on the component. The generalized behavior classifier 706 may construct sequences of states to properly represent a behavior. In the example of FIG. 7, the trajectory through a sequence of states is a behavior.

Prediction may be based on estimating the next state Q_{K+1} and next behavior Bₗ₊₁. The behavior predictor 708 (e.g., prediction module 224) may construct a probable sequences of states, based on the experience of the system in question and the dis-similarity of sequences (e.g., using a Jensen-Shannon based measure). The adaptation layer 714 may correct for changes in the underlying sequences and for prior prediction errors. In this example, the B-List 716 is an adaptive list of behaviors. Depending on the structure of this graph and the relative location of states, more than one next behavior is possible with significant probability. As a consequence, DevOps may be presented with as many as three next behaviors with their associated probability.

PAI for complex systems may be composed of a hierarchy of Q and B lists 712 and 716, one for each component under consideration.

In various embodiments, the analysis system 102 may utilize a statistical method of types. A Q state can be thought of as an empirical approximation to the generating state p. Thus, Q-List 712 is an empirical representation of the set of generating distributions pₖ kεK.

In this example, the approximation has several properties:

(1) Q states converge to the underlying distribution exponentially fast. Thus, the Multi-Look correction approach is utilized;

(2) The probability the current Q state gives rise to a candidate state w is

P[wεQ|current state Q]=2^{-nM(w∥Q)} (2)
where n is the number of samples used in computing w and

M(P∥Q)=λD(P∥φ)+(1−λ)D(Q∥φ) (3)
and

φ=argmin[|P|D(P∥M)+|Q|D(Q∥M)] (4)
and D is relative entropy. M is a dis-similarity metric. When P=Q, then M=0, and when M>0, then M is a measure of the informational dis-similarity. As a consequence as more data is aggregated with w, the probability of w being an outlier declines exponentially fast.

(3) The generalized likelihood ratio test between states is asymptotically optimal and achieves the Neyman-Pearson bound.

(4) The {Q} can be visualized in distribution space using the M metric. In this visualization, points correspond to different distributions and their relative distances, the degree of dis-similarity between distributions.

(5) The prediction accuracy is the probability that one of the set of predicted behaviors actually occurs as the next behavior. This definition reflects the fact that, when the monitored system is operating in a given behavior, it may routinely transition to more than one future behavior. For example, an ADC may respond to heavy load in more than one way, depending on the behavior of other parts of the system. Formally, prediction accuracy may be defined, in this example, as the following:

$$\frac{{Σ1}_{{B}_{i + 1} ∈ {Λ}_{i}}}{{Σ1}_{{B}_{i + 1} ∈ {Ω}_{i}}} \qquad ( 5 )$$

where Λᵢ is the set of predicted behaviors, {Bᵢ₊₁}, and may contain one, two, or as many as three elements, and Ω is the current B-List.

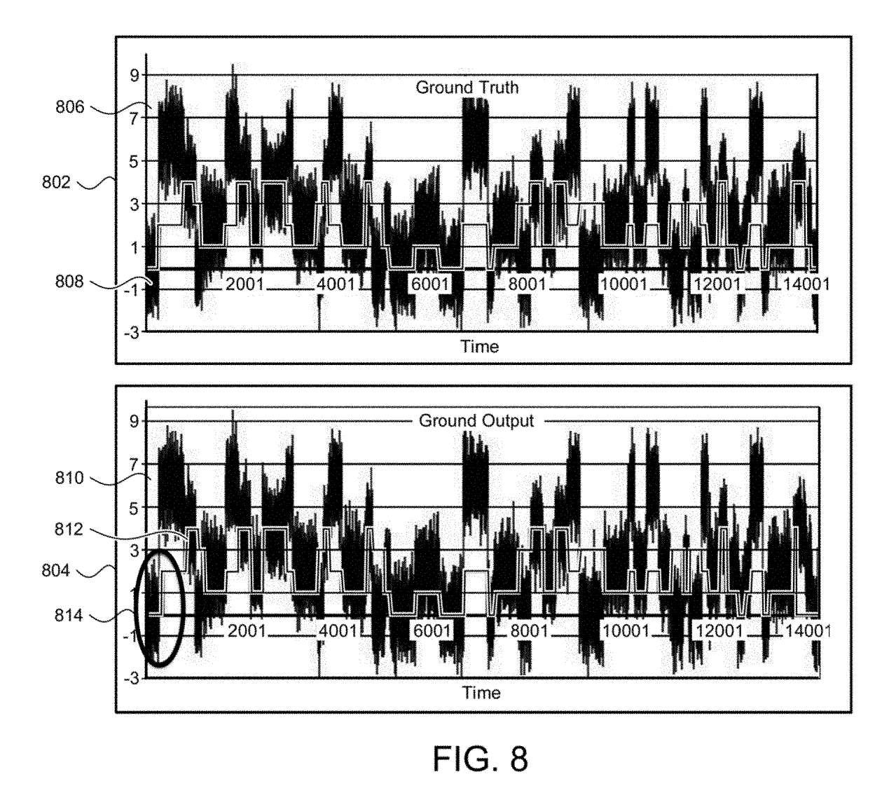

The behavior of PAI may be seen using synthetic data for which the ground truth of the generating distributions are known. FIG. 8 depicts output graphs of synthetic data in an example embodiment. In this example, six different generating distributions corresponding to six different system states are used to simulate an actual system with six behaviors. A small number of behaviors was chosen to allow interpretation. An arbitrary number of generating distributions can also be used. Each generating distribution in this example emits ten dimensional samples.

In this example, a generating distribution is chosen and samples are repeatedly collected for T₁ seconds (a randomly chosen period of time). During this time, N₁ samples are generated and fed into the analysis system. After T₁ a new distribution is chosen for a randomly chosen period of T₂ seconds. N₂ samples are collected and fed into the analysis system. The procedure is repeated (e.g., indefinitely). The six distributions in this example range from simple guassians to complex distributions described computationally.

The in graphs 802 and 804 are plots of one metric from a set of 10, xεR¹⁰ from a ten dimensional generating distribution. The inner line 808 in graph 802 corresponds to the label of the generating distribution, numbered from 0 to 5. Thus, the generating distribution labeled 0 is followed by the generating distribution labeled 2, etc.

Graph 804 is the same metric as graph 802 with Q states indicated, also by an inner line 812. As can be seen, the PAI algorithm closely tracks the generating states, after a short delay indicated by the black circle 814. A detailed comparison indicates that the GCPD correctly detects changes in the generating distributions (states) and correctly classifies the new Q states. In some embodiments, a delay is caused by PAI collecting sufficient data to declare a change.

Empirical prediction rates exceeding 99% are regularly seen for a wide array of distributions. In some embodiments, the analysis system 102 may utilize a PAI algorithm which may achieve the Neiman-Pierson theoretical performance limits, but at the cost of delay, as expected from theory.

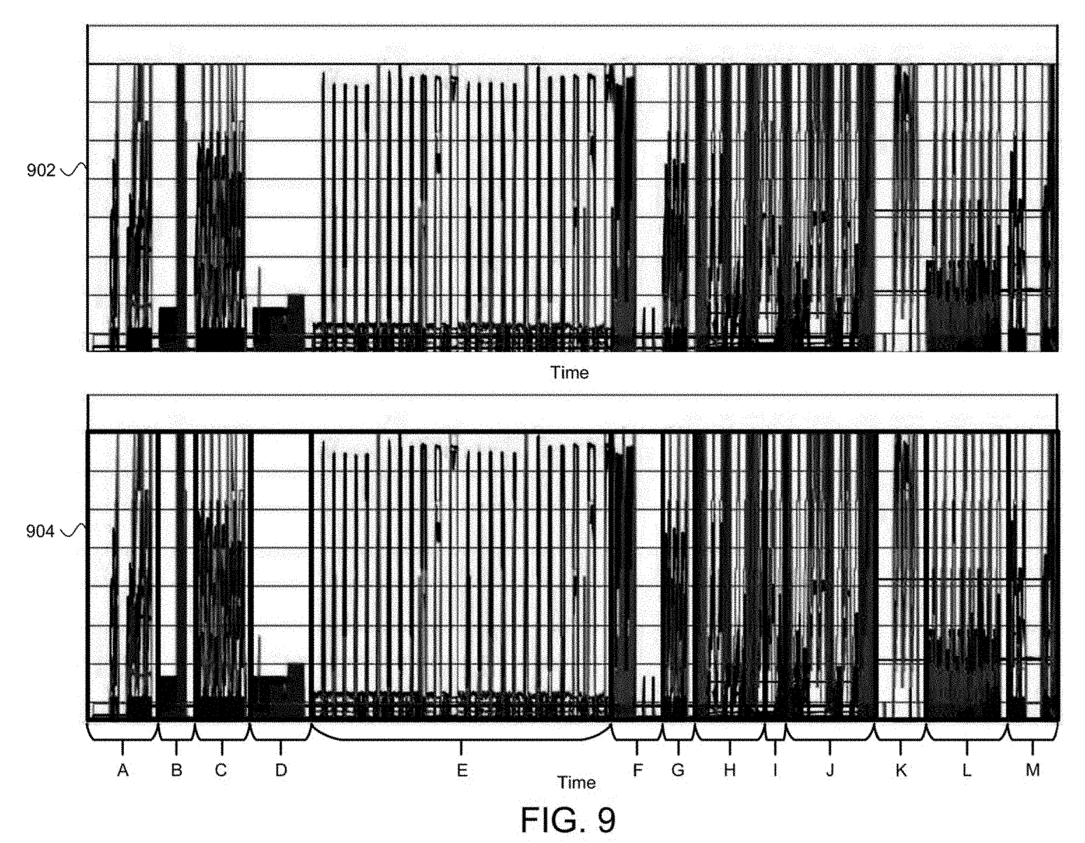

FIG. 9 depicts graphs of example behavior of PAI with MongoDB. Graph 902 shows 10 of the 100 metrics emitted by MongoDB and recorded while the database was in use. The lower panel may be color coded to indicate the states and behaviors. Regions A-M (which may be depicted in different colors such as blue, orange, red, and yellow bands) in graph 904 may correspond to different states. In this example, there is a total of 13 states. It will be appreciated that only a small portion of the data is shown in the figure.

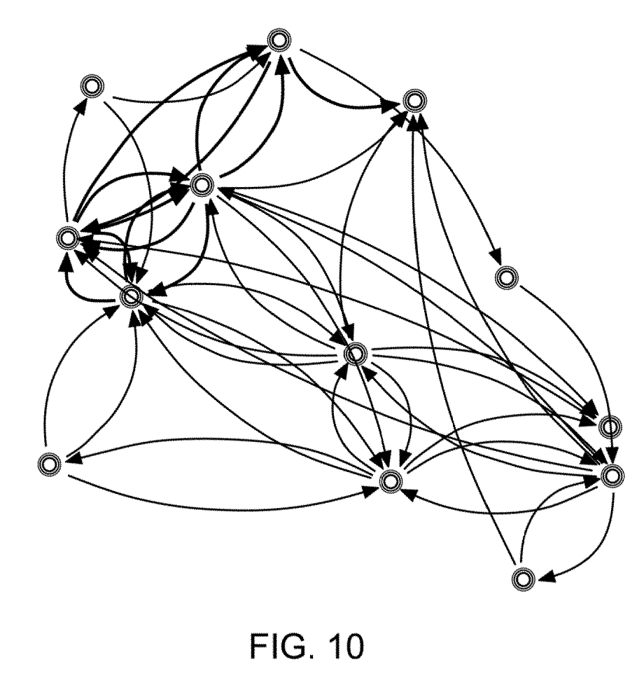

FIG. 10 shows example results of PAI with MongoDB. The analysis system 102 correctly finds the number of states indicated by DevOps. Individual states are indicated by “balls,” and correspond to a Q state in the Q-List. The arcs correspond to transitions from one state to another. The intensity of an arc corresponds to the relative frequency of that arc.

As can be seen in FIG. 10, the correlation between the Q-List and the states defined by DevOps is very high. Excluding the system inherent delay in all systems of this type, the correlation in this example 100%.

The predictive accuracy is defined as the relative frequency of the event that the next behavior is one of the predicted behaviors for this state. When run with this set of {Q} and {B} the predictive performance averaged 85%. Similar predictive performance was found for the database Postgres.

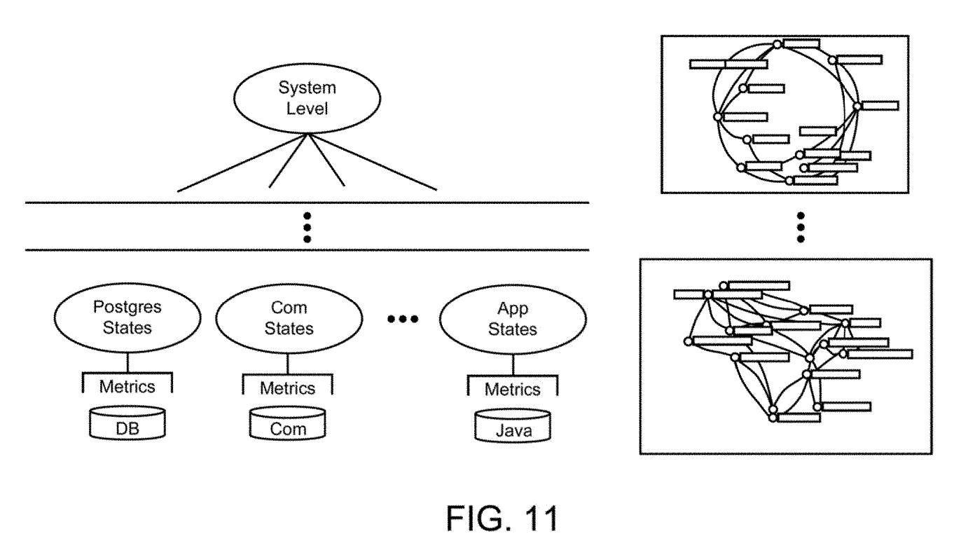

In another example, a complex system composed of a DB (Postgres), twenty communications servers, an applications server and micro-services was also analyzed. FIG. 11 depicts a system structure and the Q-List for an example system and one of the components. The Q-List for the system is computed from the Q-List for each of the components including, but not limited to, DB, Comm servers, and/or App servers. In some embodiments, warnings at the top level can be traced to the offending components and to the most likely offending metrics, giving immediate context to any predicted problem.

Table 2 shows the prediction accuracy in this example, which varies by component:

Prediction Accuracy

| Component | Average Accuracy |
|---|---|
| DB | 87% |
| Comm | 85% |
| App Server | 84% |

In this table, database accuracy is highest at 87% with the custom App Server offering the lowest accuracy at 84%.

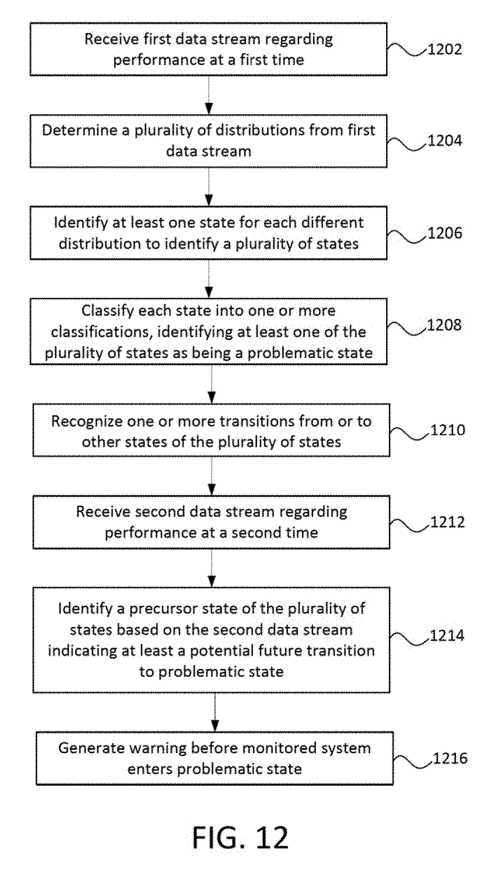

FIG. 12 is a flowchart for analyzing streaming data and providing warnings in some embodiments. It will be appreciated that steps 1202-1210 may include the analysis system 102 learning a monitored system. In learning, the analysis system 102 may identify states, classify states, identify problematic states (e.g., states with adverse conditions), and identify likely transitions between states. In steps 1212-1216, the analysis system 102 may determine a current state of the monitored system from new streaming data, predict the possibility of transitioning to the identified problematic state(s), and provide warnings to avoid the problematic state(s). It will be appreciated that the analysis system 102 may continue to learn and identify new states, including new problematic states while performing steps 1212-1216, however, enough may be learned about the behavior of the monitored system to enable the analysis system 102 to take meaningful action (e.g., generate warnings and/or take proactive action to change the current state of the monitored system to avoid the problematic state).

In step 1202, the input module 216 receives a first data stream regarding performance of a monitored system at a first time. The first data stream may be received from any number of sources (e.g., different APM tools, log tools, applications, databases, subsystems, and/or systems).

In step 1204, the distribution module 218 determines a plurality of distributions from the first data stream. In some embodiments, the distribution module 218 may generate non-parametric distributions as discussed herein.

In step 1206, the change point module 220 may identify at least one state for each different distribution of the plurality of distributions to identify a plurality of states. In various embodiments, the change point module 220 may determine different states by determining similarity and/or dis-similarity of the different distributions (e.g., using Jensen-Shannon divergence).

In step 1208, the classification module 222 may classify any number of the states of the plurality of states. In various embodiments, the classification module 222 may receive labels or other classification information from a database and/or operator regarding the different states. In some embodiments, the classification module 222 may receive labels or other categorization information from APM tools, databases, and/or applications. In some embodiments, the classification module 222 identifies at least one of the plurality of states as being a problematic state.

In step 1210, the change point module 220, the classification module 222, and/or the prediction module 224 recognize transitions between any of the states (e.g., from one state to another or to a state from another state). In some embodiments, the visualization engine 228 may optionally generate a visualization of nodes and edges depicting performance. The visualization engine 228 may, in some embodiments, generate any number of dashboards depicting metrics, streaming information, distributions, states, classifications, and/or predictions.

In step 1212, the input module 216 receives a second data stream indicating performance at a second time of the monitored system. In step 1214, the prediction module 224 identifies a precursor state of the plurality of states based on the second data stream indicating at least a potential future transition to the problematic state. A precursor state may be any state with a likelihood of transitioning to a problematic state with an adverse condition. In one example, a precursor state may appear to always transition ultimately to a problematic state based on past system behavior (e.g., based on behaviors identified in the first data stream). In another example, a precursor state may appear to likely transition to a problematic state based on past system behavior (e.g., there may be multiple transitions from the precursor state one of which being a problematic state or the precursor state will transition to a state that will subsequently likely transition to the problematic state).

In step 1216, the warning module 226 may generate a warning before the monitored system enters the problematic state (e.g., before the current behavior of the monitored system transitions to the problematic state). As discussed herein, the warning may be generated and provided to any number of digital devices, applications, databases, users, or the like prior to the monitored system reaching the problematic state (e.g., before the adverse condition is reached).

FIGS. 13-21 depict example dashboards indicating performance, interactions, and monitoring of an example monitored system in some embodiments. FIG. 13 is an example prediction dashboard in some embodiments. The top portion of the prediction pane shows the current behavior of various components. As shown in FIG. 13, the webserver is in “Fluctuating Traffic” behavior. The notes reveal that the Webserver is high number of page faults and CPU usage. The current behavior of each component is also given a color coding which represents the severity of the behaviors. The severity level can range from “Green: Normal,” “Yellow: Observe,” “Orange: Warning,” and “Red: Critical.” These color coding allow the operators to quickly understand the condition of their components as well as their severity level.

The bottom portion of the pane shows future predicted behaviors for each of the component. For example, the system predicts that the Database is likely to transition from its current behavior of “Normal-3” to “Increasing Traffic” with 72.2% probability. It is also possible that the Database might transition to “Normal-5” behavior with 18.9% probability.

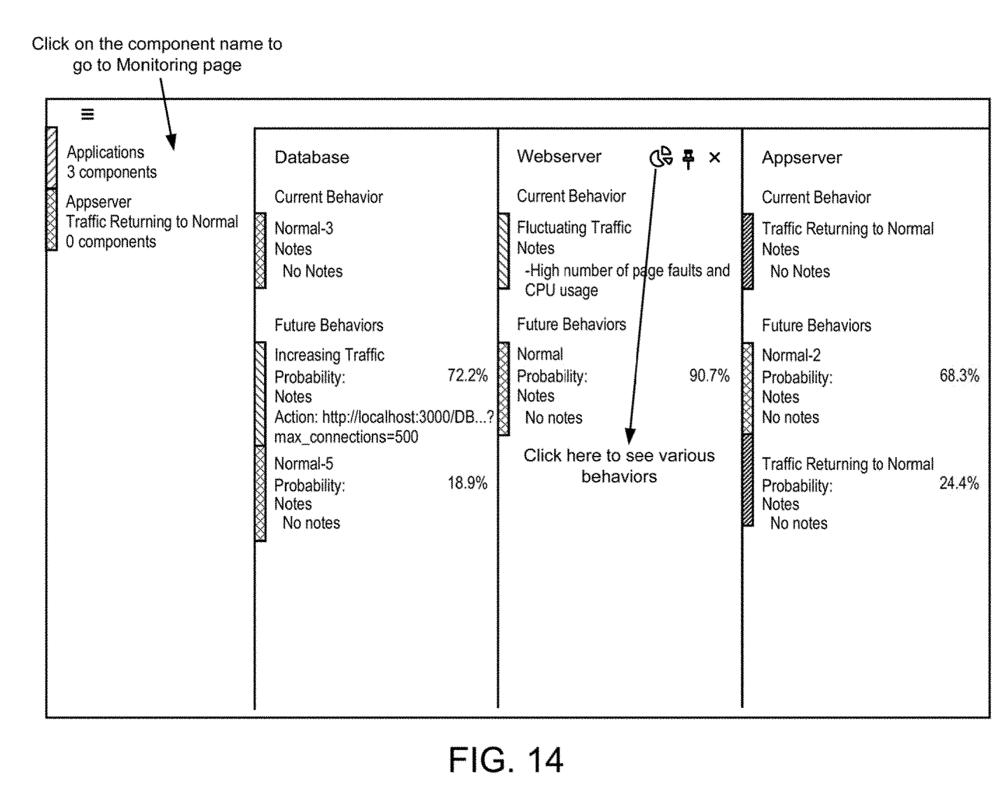

FIG. 14 is an example interaction prediction dashboard in some embodiments. As shown in FIG. 14, clicking on the name of the component may cause the dashboard to navigate to the monitoring pane which shows various metrics associated with that component. The icon on the right of each component allows the user to see various behaviors associated with that component.

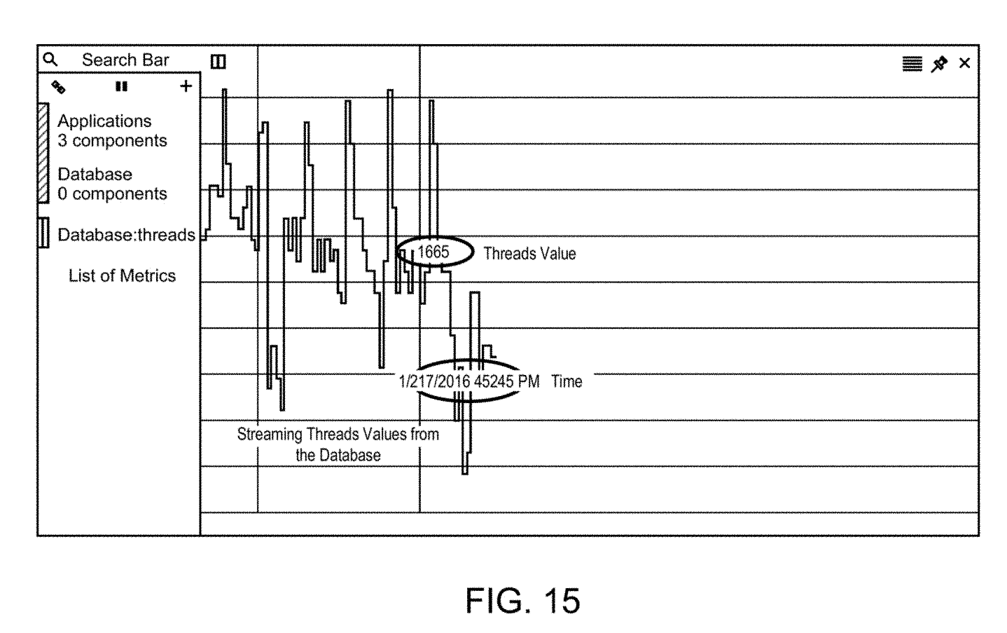

FIG. 15 is an example monitoring dashboard in some embodiments. To start monitoring feature of the application, a user may click on one of the components. FIG. 15 depicts a dashboard for monitoring a database. The application starts by displaying the first metric associated with this component, which in this case is the “Threads.” FIG. 15 shows the streaming values of the Threads from the Database. By moving the vertical cursor, the dashboard displays the time and the actual value of the Threads at that time. For example, on “1/27/2016, 4:53:45 PM,” the number of Threads in the Database are 1665.

At the bottom of FIG. 15 is the list of all metrics associated with the Database. Currently the list only includes the one metric that is being displayed. To add other metrics associated with the Database, we use the search bar on the top of the left pane.

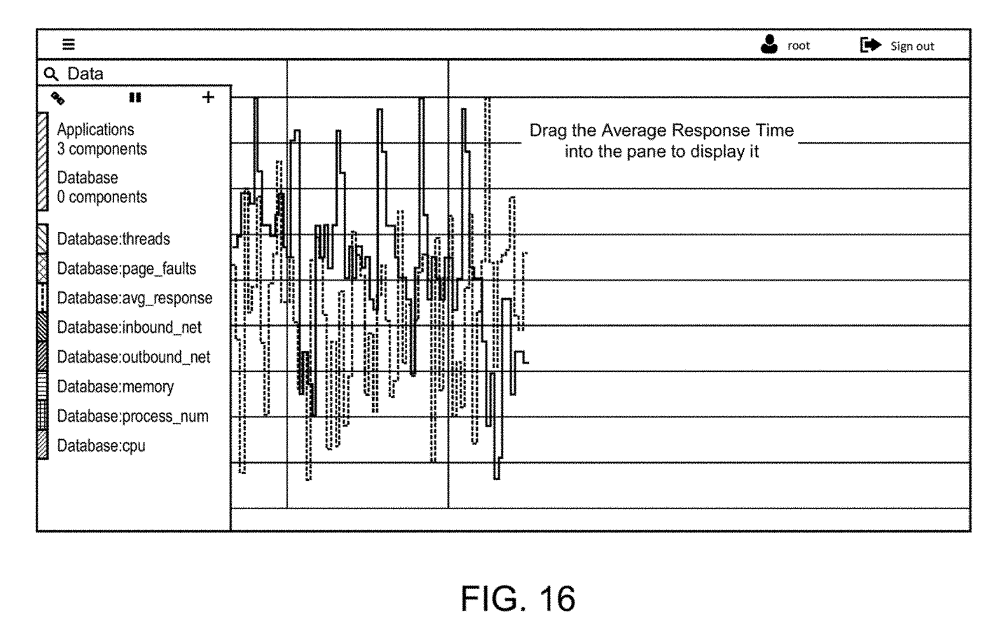

FIG. 16 is an example monitoring dashboard to view multiple metrics associated with a database in some embodiments. FIG. 16 shows “Threads,” and the “Average Response Time” for the Database.

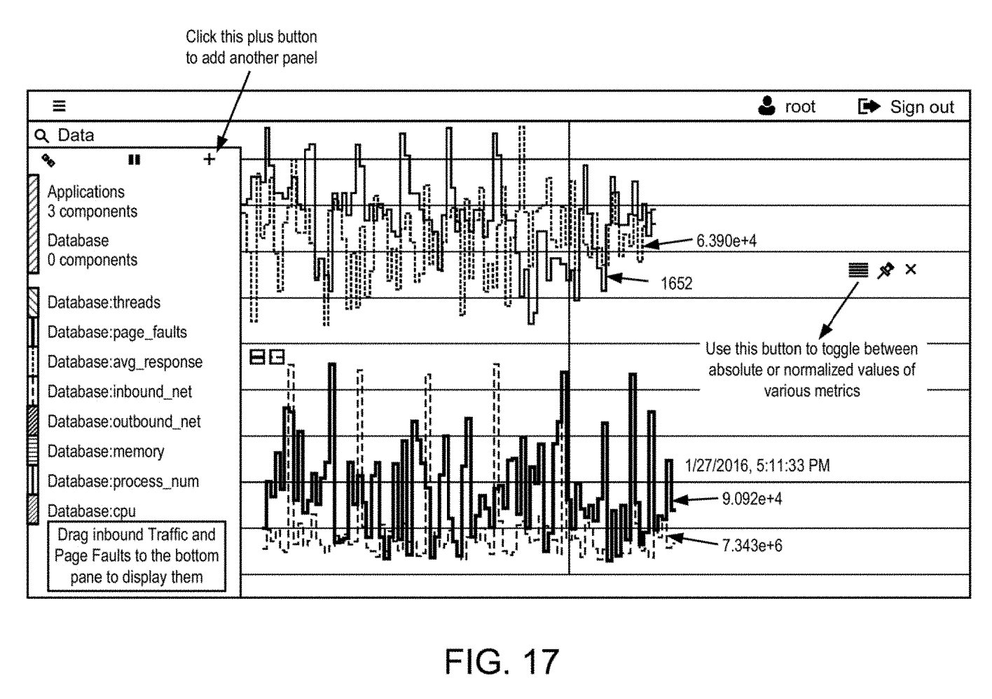

FIG. 17 is an example monitoring dashboard including multiple panes in some embodiments. In some embodiments, a user may add multiple panes that allows the operator to display and/or separate unrelated metrics. In this example, an operator may engage the “plus” button on the top right corner of the left pane. The operator may drag the metrics from the left list of metrics to this new pane to start displaying them.

In FIG. 17 the second pane displays the “Inbound Network Traffic” and the “Page Faults.” The two metrics are on different scales. To bring the two metrics on same scale, the operator may toggle the button on the top right of the pane to switch between absolute or normalized display. This allows you to visualize different metrics that are on different scale.

Moving the vertical cursor, may display the time as well as the values of all metrics across multiple panes. In FIG. 17, the cursor displays the time as well as the values of the “Threads,” “Average Response Time” in the top pane and “Inbound Network Traffic” and “Page Faults” in the bottom pane.

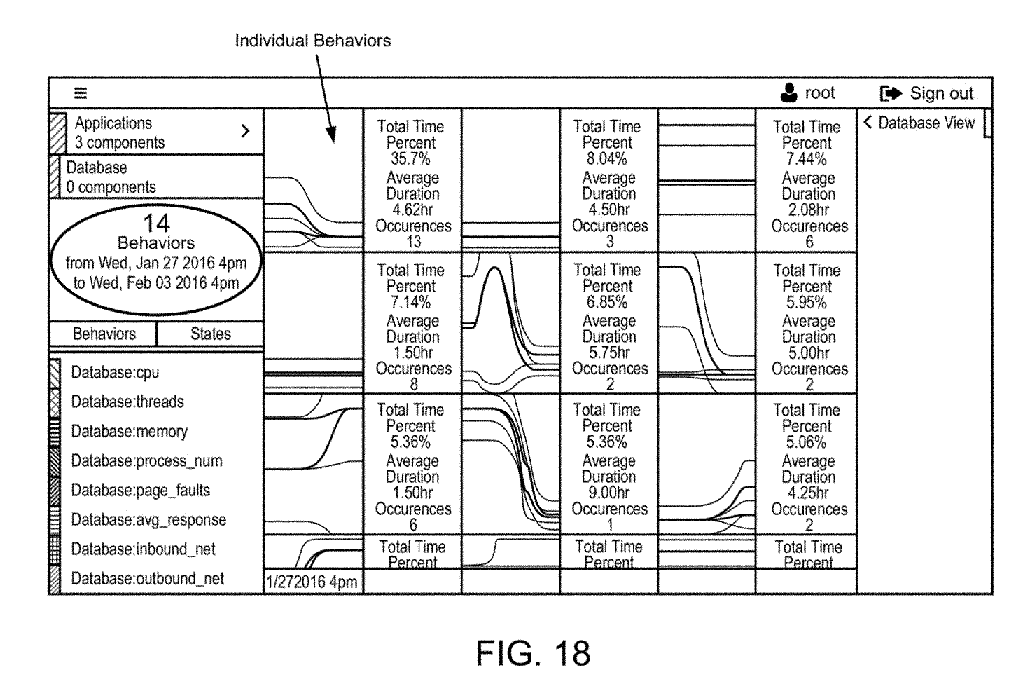

FIG. 18 is an example behavior dashboard to view shapes of streaming data in some embodiments. The displays of the shape of data may summarize and succinctly describe the condition of a monitored system. The displays of the shape of data may be much easier to interpret than raw performance data. By labeling various behaviors, users can quickly understand the condition of their system as well as the severity of any problem that the system might be encountering. FIG. 18 displays individual behaviors for the database. The legend on the bottom left shows colors used to represent each metric. For example, the “Average Response Time” is shown in pink and the “Page Faults” are shown in purple.

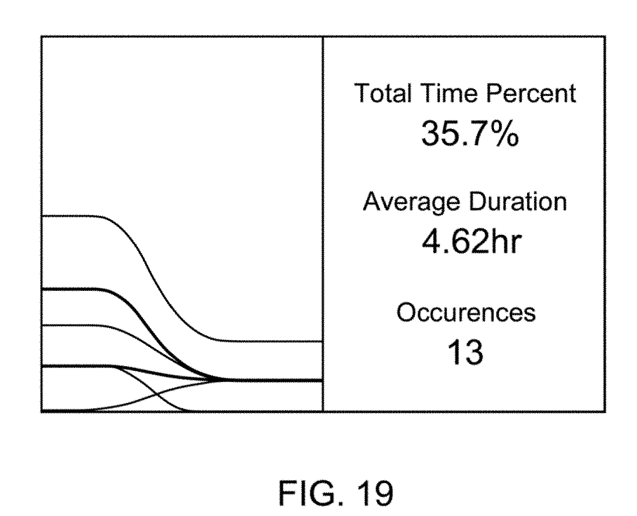

FIG. 19 shows the displays details of a particular behavior. Behaviors are computed using available metrics. In some embodiments, the analysis system 102 may display two metrics that differentiate each behavior from other behaviors. Additional metrics can be displayed at any time. For example, behavior may be characterized by “CPU” and the “Average Response Time.” The spread around these curves may show the variances of the metrics associated with this behavior. For each behavior or shape, the analysis system 102 may also computes statistics about the occurrence of the behavior. In the example depicted in FIG. 19, the system spent about 35% of the time in this behavior. There are 13 different occurrences of this behavior and each occurrence lasted on average 4.62 hours.

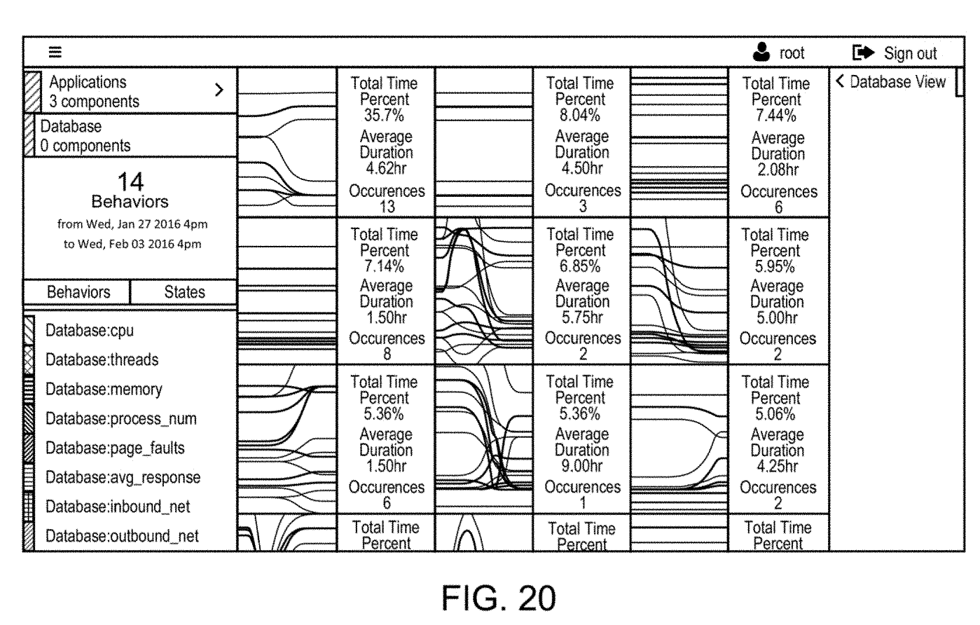

FIG. 20 is a dashboard for interpreting and comparing behaviors in some embodiments. In order to interpret and compare behaviors, the dashboard may display metrics associated with the behavior. By selecting a metric, the analysis system 102 may display the given metric to all behaviors. FIG. 20 shows Database behaviors with various metrics added to different behaviors.

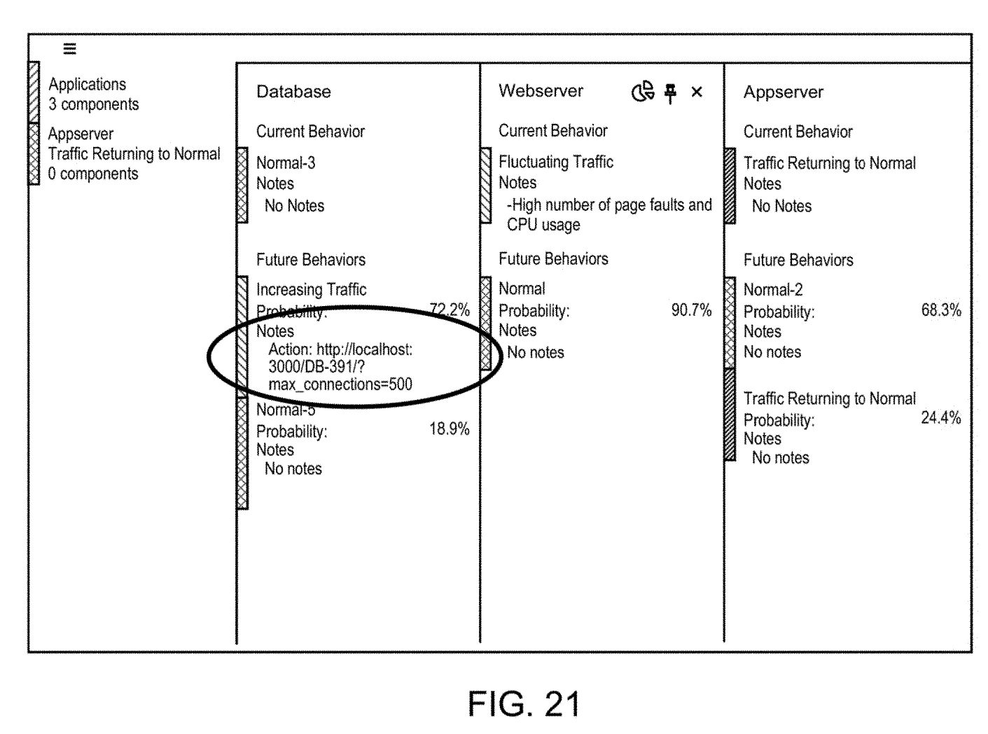

FIG. 21 is a dashboard for remediation in some embodiments. As discussed herein, the analysis system 102 may display current behavior of the system. The analysis system 102 may also display information regarding future predicted behaviors. For each behavior users can associate various actions—these actions may be “shell scripts” or pointers to “REST APIs.”

In some embodiments, an operator may annotate a given behavior and/or associated a behavior with an action. When the analysis system 102 may identifies the given behavior, the analysis system 102 may automatically take that action or make a recommendation to the user to take that action.

The above-described functions and components can be comprised of instructions that are stored on a storage medium (e.g., a computer readable storage medium). The instructions can be retrieved and executed by a processor. Some examples of instructions are software, program code, and firmware. Some examples of storage medium are memory devices, tape, disks, integrated circuits, and servers. The instructions are operational when executed by the processor (e.g., a data processing device) to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method comprising:
receiving a first data stream regarding performance of a monitored system at a first time;
determining a plurality of distributions from the first data stream;
identifying at least one state for each different distribution of the plurality of distributions to identify a plurality of states;
classifying each of the plurality of states into classifications, identifying at least one of the plurality of states as being a problematic state;
for each state of the plurality of states, recognizing one or more transitions from or to other states of the plurality of states;
receiving a second data stream indicating performance of the monitored system at a second time;
identifying a precursor state of the plurality of states based on the second data stream indicating at least a potential future transition to the problematic state; and
generating a warning before the monitored system enters the problematic state, thereby enabling the monitored system or an operator to make changes in the monitored system to reach another state of the plurality of states before the transition to the problematic state.

2. The method of claim 1, wherein the data stream includes data from a sensor or transactional business data.

3. The method of claim 1, wherein the data stream is received from application performance management (APM) tools providing metric information regarding performance of at least one application.

4. The method of claim 1, wherein determining the plurality of distribution from the data stream comprises computing probabilities across dimensions of the first data stream and aggregating the probabilities into the plurality of distributions.

5. The method of claim 1, further comprising generating a list of states based on the identified plurality of states.

6. The method of claim 1, wherein the first data stream is regarding a single metric of the monitored system.

7. The method of claim 1, wherein identifying the precursor state of the plurality of states based on the second data stream includes identifying the precursor state based on an expected future transition to the problematic state utilizing, at least in part, behaviors identified from the first data stream.

8. The method of claim 1, further comprising taking action in the monitored system to change a current state of the monitored system from the precursor state to a different state.

9. The method of claim 1, further comprising displaying a dashboard displaying information regarding at least one of the states of the plurality of states based, at least in part, the second data stream.

10. A non-transitory computer readable medium comprising instructions, that, when executed, cause one or more processors to perform a method, the method comprising:
receiving a first data stream regarding performance of a monitored system at a first time;
determining a plurality of distributions from the first data stream;
identifying at least one state for each different distribution of the plurality of distributions to identify a plurality of states;
classifying each of the plurality of states into classifications, identifying at least one of the plurality of states as being a problematic state;
for each state of the plurality of states, recognizing one or more transitions from or to other states of the plurality of states;
receiving a second data stream indicating performance of the monitored system at a second time;
identifying a precursor state of the plurality of states based on the second data stream indicating at least a potential future transition to the problematic state; and
generating a warning before the monitored system enters the problematic state, thereby enabling the monitored system or an operator to make changes in the monitored system to reach another state of the plurality of states before the transition to the problematic state.

11. The non-transitory computer readable medium of claim 10, wherein the data stream includes data from a sensor or transactional business data.

12. The non-transitory computer readable medium of claim 10, wherein the data stream is received from application performance management (APM) tools providing metric information regarding performance of at least one application.

13. The non-transitory computer readable medium of claim 10, wherein determining the plurality of distribution from the data stream comprises computing probabilities across dimensions of the first data stream and aggregating the probabilities into the plurality of distributions.

14. The non-transitory computer readable medium of claim 10, further comprising generating a list of states based on the identified plurality of states.

15. The non-transitory computer readable medium of claim 10, wherein the first data stream is regarding a single metric of the monitored system.

16. The non-transitory computer readable medium of claim 10, wherein identifying the precursor state of the plurality of states based on the second data stream includes identifying the precursor state based on an expected future transition to the problematic state utilizing, at least in part, behaviors identified from the first data stream.

17. The non-transitory computer readable medium of claim 10, wherein the method further comprises taking action in the monitored system to change a current state of the monitored system from the precursor state to a different state.

18. The non-transitory computer readable medium of claim 10, wherein the method further comprises displaying a dashboard displaying information regarding at least one of the states of the plurality of states based, at least in part, the second data stream.

19. A system comprising:
one or more processors; and
memory comprising instructions to configure at least one of the one or more processors to:
receive a first data stream regarding performance of a monitored system at a first time;
determine a plurality of distributions from the first data stream;
identify at least one state for each different distribution of the plurality of distributions to identify a plurality of states;
classify each of the plurality of states into classifications, identifying at least one of the plurality of states as being a problematic state;
for each state of the plurality of states, recognize one or more transitions from or to other states of the plurality of states;
receive a second data stream indicating performance of the monitored system at a second time;
identify a precursor state of the plurality of states based on the second data stream indicating at least a potential future transition to the problematic state; and
generate a warning before the monitored system enters the problematic state, thereby enabling the monitored system or an operator to make changes in the monitored system to reach another state of the plurality of states before the transition to the problematic state.

20. The system of claim 19, wherein the data stream is received from application performance management (APM) tools providing metric information regarding performance of at least one application.
